(19) United States
(12) Patent Application Publication
(10) Pub. No.: US 2026/0111479 A1
(43) Pub. Date: Apr. 23, 2026

(54) QUERY OPTIMIZATION FOR GENERATIVE MACHINE LEARNING MODELS

(71) Applicant: Microsoft Technology Licensing, LLC, Redmond, WA (US)

(72) Inventors: Jinghua CHEN, Redmond, WA (US); Deepika PURI, Syosset, NY (US); Pramod Kumar GUPTA, Hyderabad (IN); Phanindra PAMPATI, Sammamish, WA (US); Gautam PRASAD, Hyderabad (IN); Sanket SHAH, Kirkland, WA (US); John J. WANG, Bellevue, WA (US); Sri Harsha KAMMA, Hyderabad (IN)

(21) Appl. No.: 18/948,431

(22) Filed: Nov. 14, 2024

(30) Foreign Application Priority Data
Oct. 18, 2024 (IN) 202411079147

(51) Int. Cl. G06F 16/383; G06F 16/338

(52) U.S. Cl. CPC G06F 16/383; G06F 16/338

(57) ABSTRACT

In some examples, a seed query is received. A set of candidate queries is retrieved from a database based on matching the seed query with each candidate query. Based on the seed query, a ranking model is used to assign a relevance score to each candidate query. The relevance score indicates suitability of the candidate query as a follow-up query to the seed query (“next query” suitability). At least one candidate query is outputted based on the relevance scores. For example, candidate queries may be ordered or filtered based on their relevancy scores. In some implementations, an action is instigated automatically or semi-automatically based on a model-generated response to a candidate query. In some implementations, generative model calls are instigated on the seed query and a next query selected from the candidate next queries.

### TECHNICAL FIELD

The present disclosure pertains to query optimization for generative machine learning (GML) models.

### BACKGROUND

GML models have seen rapid development in recent months and years. Examples of GMLs include generative language models (LMs), such as large language models (LLMs), multi-modal GMLs (e.g. operating on two or more modalities, such as text, image audio etc.), image-based or audio-based models (e.g. direct audio-to-audio GMLs).

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

In some examples, a seed query is received. A set of candidate queries is retrieved from a database based on matching the seed query with each candidate query. Based on the seed query, a ranking model is used to assign a relevance score to each candidate query. The relevance score indicates suitability of the candidate query as a follow-up query to the seed query (referred to as “next query” suitability). One or more candidate next queries are outputted based on the relevance scores. For example, candidate queries may be ordered or filtered based on their relevancy scores. In some implementations, an action is instigated automatically or semi-automatically based on a model-generated response to a candidate query. In some implementations, generative model calls are instigated on the seed query and a next query selected from the candidate next queries.

### BRIEF DESCRIPTION OF FIGURES

Embodiments will now be described by way of example only with reference to the following figures, in which:

FIG. 1 shows a schematic block diagram of an example computer system that provides an interface to GML functionality, and example pipeline steps performed therein;

FIG. 2 shows a schematic diagram of example offline processing system used to populate a query database;

FIG. 3 shows a schematic block diagram of an example ranking model training set-up;

FIG. 4 shows a schematic block diagram of an example graphical user interface; and

FIG. 5 shows a schematic block diagram of an example hardware implementing environment.

### DETAILED DESCRIPTION

A portion of the disclosure of this patent document contains material which is subject to copyright protection, such as template prompts, example model outputs etc. The copyright owner has no objection to the facsimile reproduction by anyone of the patent document or the patent disclosure, as it appears in the Patent and Trademark Office patent file or records, but otherwise reserves all copyright rights whatsoever.

GML models, referred to herein as generative models (GMs) for conciseness, have demonstrated significant potential across a wide range of application domains. To take one example, in the field of cybersecurity, a GM can be used to support investigations by a security expert, enabling potential security threats to be identified and mitigated. In one example application, a GM(s) is used to analyze a dataset that records entity activity within a computer system (e.g. computer device or multi-device system) or computer network, to detect incidents of anomalous behavior or other potentially suspicious behavior incidents, and even to determine appropriate remediation actions. In some implementations, the dataset takes the form of an external structured knowledge base (external to the GM). Examples of suitable GML architectures include GPT, Falcon, Llama etc. Examples of such activity include a breach of a security policy, or an incident of activity that does not breach an existing policy, but which nevertheless may pose a security risk. One use case for the latter is using a GM to determine an appropriate security policy (e.g. data retention policy) to be implemented. A key benefit of a GM is that it can be applied to tasks defined at inference that it has not been explicitly trained on. In a security context, a benefit over conventional analysis tools (such as statistical anomaly detectors or trained deterministic threat classifiers) is that a GM can perform custom forms of analysis (indicated at inference), such as bespoke detection or bespoke remediation tasks (such as determining an appropriate security policy for mitigating an identified threat or vulnerability). In some examples, a system enables a user to query data security information, and manage and investigate alerts using open queries, such as natural language prompts. In some embodiments, a system is configured to perform a security mitigation action based on a GM detection. Examples of such actions include generating an alert (e.g., in a graphical user interface), revoking or restricting an access privilege of an entity associated with the detection, quarantining an entity associated with the detection, or isolating from a computer system or a computer network an entity associated with the detection. In some cases, a security mitigation action is triggered automatically in response to the detection. In other cases, a security mitigation action is triggered in response to user input. For example, in some examples, an alert is triggered automatically, and a selectable option or options for triggering a further security mitigation action or actions (such as quarantining an entity) is presented. Examples of entities include users, user accounts or user identifiers, tenants (e.g. cloud tenants) such as individuals or organizations, physical or virtual devices, processes, applications, services (e.g. cloud services), files, network addresses etc.

In some contexts, effective interaction with a GM requires multiple queries (e.g., prompts) to be provided to the GM. Several problems arise in this context. A user will sometimes struggle with determining an appropriate follow-up prompt or an overall direction for advancing an analysis. A prompt input can be cluttered and may not be structured optimally to draw out the most effective response from a GM. Users may also experience ‘prompt fatigue’ and become reluctant to input detailed prompts after a certain point. Any of these factors can hinder GM performance. The same factors can also lead to inefficient use of resources in a computer system hosting a GM and related infrastructure. Each time a query is received, the system invokes a GM call on the query. In some implementations, a GM call means simply inputting the query to a GM to execute the GM on the query. In other implementations, a GM call involves additional steps of selecting a GM (e.g. a domain-specific GM) from multiple possible GMs and/or augmenting the query with additional data (e.g. domain specific data) e.g., to effect a prompt/query engineering process. In either case, each GM call consumes significant computational resources. For current state-of-the-art GMs (e.g., transformer architectures with of the order of a billion parameters or more), even a single call to a GM requires significant computational resources to execute. If additional steps are performed to select a GM and/or to augment the query, the computational burden per-query is further increased. If a user fails to optimally structure their prompts, significant computational resources can, therefore, be wasted though ineffective user-GM interactions.

One the one hand, much of the power and flexibility of GMs stems from their ability to interpret open queries, such as free-form natural language queries. On the other hand, excessive use of open queries can hinder GM performance and make inefficient use of computational resources.

A predictive “next prompt” query mechanism is described herein. Given an open “seed” query (e.g. some user-defined query), one or more predetermined candidate queries are selected as potential “follow up” queries. The predictive query mechanism aims to limit open prompt usage by providing a broad and contextually relevant set of follow-up candidates. This enables improved GM performance and more efficient use of computational resources. In a security context, improved GM performance yields a consequent improvement in security as a consequence of improved detection performance and/or improved remediation performance (e.g., when a GM is used to determine appropriate remediation actions). In some implementations, an interactive graphical user interface (GUI) is provided, which is configured to receive user-defined open queries (e.g. the seed query) and output model-generated responses. Recommended next queries are displayed as selectable elements within the interactive GUI, enabling a user to automatically instigate a GM call on a recommended query by selecting the corresponding element, without having to manually input its content. This provides a more efficient user-machine interaction mechanism. Computational resources are saved in a computer system implementing a generative model (or generative models) by selecting and ranking candidate next queries. In particular, a computational resource saving is achieved by retrieving from a database a candidate query based on matching the seed query with the candidate query, using a ranking model to assign a relevance score to the candidate query based on the seed query, and using the candidate query and the relevance score to guide a subsequent interaction with the generative machine learning model(s).

In a security use case, a security mitigation action of the kind described above is performed based on a model-generated response to a selected candidate next query in some implementations. Other use cases are also considered encompassing a wide range of possible actions. Other examples of actions include image classification or extracting information from images (e.g., classifying images, image regions, or image pixels; locating objects in images, e.g., by predicting object bounding boxes, etc.); text classification; the extraction of structured or semi-structured information from text; audio signal classification (e.g., classifying different parts of an audio signal, e.g., in the context of voice recognition, to separate speech from non-speech, or to convert speech to text); extracting information from sensor signals, e.g., extracting measurements or insights from signals from one or more sensors, for example, in a machine control application (e.g., such measurements may be used to measure physical characteristics of or relevant to a machine or system such as a vehicle, robot, manufacturing system, energy production system, etc.), or in a medical sensing application such as patient monitoring or diagnostics (e.g., to monitor and classify a patient's vitals). Other applications include generating images such as static images or video images (e.g., based on a text or non-text input), text (e.g., translating text from one language to another, or generating a response to a user's text input), audio data (e.g., synthetic speech, music, or other sounds) or music (e.g., in digital or symbolic music notation), computer code that may be executed on a processor (e.g., computer code to control or implement a technical process on a computer or machine, e.g., generating code in response to a user's instructions express in natural language, translating or compiling code, such as source code, object code or machine code, from one programming language to another); and modeling or simulation of physical, chemical, and other technical systems, or discovering new chemical components or new uses thereof (including ‘drug discovery’ applications, to discover new therapeutic compounds or medicines, or new therapeutic uses). In any of the aforementioned example, appropriate actions can be automatically determined (and, in some implementations, automatically performed) based on a model-generated response to a selected next query.

Candidate queries are predetermined and stored in a database. In some implementations, each candidate query is associated with an embedding vector. A seed query is encoded using a pre-trained encoder, resulting in a seed embedding vector that is used to select some number of candidate queries based on similarity of their embedding vectors with the seed embedding vector. In some embodiments, the same pre-trained encoder is used to generate the candidate query embedding vectors that are pre-stored in the database. Examples of suitable encoders include BERT and ROBERTA.

In this context, relevant candidate queries are selected on the basis they exhibit some embedding similarity with the seed query. However, in the present context, the aim is to provide a useful next query. If a candidate query is too similar to the seed query, it is unlikely to be relevant in this context, and is more likely to simply be a rephrasing of the seed query. Therefore, in some examples, having selected a number of candidate queries, candidate pre-processing is performed to remove or de-prioritize candidate queries that are too similar to the seed query.

Having determined an appropriate set of candidate queries (with pre-processing, if applicable), a specifically-trained raking model is used to determine their relative relevance to the seed query. In this context, “specifically-trained” means the ranking model has been trained on an explicit query ranking task. In one example, the ranking model is implemented as a discriminative (non-generative) regression model that assigns a relevance score to each candidate query based on the seed query. In another example, the ranking model is implemented as a non-generative classification model that classifies each candidate query based on relevance to the seed query.

This contrast with an alternative approach of using a GM to generate candidates, which has various drawbacks. This also contrasts with an approach that uses a GM to rank predetermined candidates. One of the challenges of using GPT for ranking tasks is its inability to consume feedback signal from users. Moreover, it is challenging to translate user feedback to instruction at inference, which limits the scope for prompt engineering. Also, certain GM architectures (e.g. Generative Pre-Trained Transformers) tend to perform poorly when instructed to assign a pointwise score, which is an important step for ranking in some example implementations. For comparative ranking, a long list of prompts needs to be inputted for ranking, and certain GML architectures (e.g. GPT) are known to favor text are at the beginning or end of a list. Generating a ranked output with a GM would also have higher latency and typically consume more computational resources than using a specifically-trained ranking model.

When using a specifically-trained ranking model, a GML (e.g., GPT) model is used in some embodiments to generate clean training data. That training data is, in turn, used to train an ML ranking model, such as a deep learning (DL) model and/or reinforcement learning (RL) model. This approach overcomes the shortcomings of such GMs whilst still leveraging their strength.

Some implementations are based on predefined GM “skills”. A GM skill means a GM with some level of domain-specific customization. Here, the breadth of a “domain” is highly context-dependent. For example, in one security implementation, “data security” and “malware detection” might be treated as separate skill domains. Another security implementation has more granular skills domains, e.g. with “data security analytics” and “data security remediation” implemented as separate skill domains (the former encompassing the detection of data security breaches, and the latter encompassing remediation actions such as data security policy implementation). There are various GM customization mechanisms that can be used to implement a GM skill. For example, a GM skill may be implemented as a GM that has been fine-tuned on a domain-specific task. Fine-tuning is merely one example of a customization mechanism that can be used to implement a defined skill. Another example is prompt engineering; for example, a user-defined prompt may be augmented with an additional instruction(s) or example(s) before it inputted to a GM, such as an instruction to operate in a particular role (e.g. data security expert), or with an example of a domain-specific output.

In one implementation, when a GM call is initiated on a seed prompt, content of the seed prompt (e.g. its natural language content) is initially processed to select an appropriate GM skill. This involves some level of skill orchestration processing applied to the seed query to determine and invoke an appropriate GM skill (e.g. from multiple predetermined GM skills) from the content of the seed query.

In some implementations, follow up queries are selected within the boundary of a defined GM skill, thereby preventing a drift into topics that do not align with an available skill. Note, the skill associated with a follow-up query is not necessarily the same as the skill selected for the seed query, and different follow-up queries may relate to different GM skills in some cases.

Skill orchestration requires additional computational resources and introduces additional latency to determine an appropriate GM skill before it is invoked. In some implementations, candidate queries are stored in the database in association with structured metadata indicating an applicable GM skill. This means that, unlike the seed query, skill orchestration can be bypassed for the predetermined candidate queries, enabling them to be processed with reduced computational resources and reduced latency. This benefit is achieved because the GM skill appropriate to a candidate query is selected directly from its structured metadata, without having to interpret its content for this purpose. The structured metadata contains additional parameter(s) in some examples that are used to further improve the efficiency of GM skill invocation.

In such embodiments, additional computational resources are thus saved in a computer system implementing a generative model(s) by using predetermined metadata associated with the candidate query to guide selection of an appropriate GML skill, bypassing computationally expensive skill orchestration that would otherwise be required to achieve a comparable outcome.

When a call to a GM is initiated on a given query, that query is inputted to a GM, and the GM returns a response. As discussed, in some cases this involves selecting a GM skill from multiple available GM skills (e.g., implemented using fine-tuning, prompt augmentation etc.). In some embodiments, different GMs are sometimes used to process different queries. In other embodiments, a single GM is used to process all queries.

In some embodiments, the response to the seed query is used in the selection of candidate queries. In some such embodiments, the model response is converted to a structured format to enable it to be used more effectively for candidate next query selection. In other embodiments, the seed query is used but the model response is not used to select candidate queries.

Table 1 considers example scenarios in a cybersecurity use case.

### Example Scenarios

TABLE 1

| | |
|---|---|
| What are the alerts which | 1. How many users are identified in the |
| need immediate attention? | above alerts? |
| | 2. What are the user risk profiles |
| | associated with this alert? |
| | 3. Which file has been exfiltrated and |
| | what's the location? |
| Which users have the | 1. What is the risk profile of the |
| maximum data | users? |
| exfiltration alerts in | 2. Which department and locations of |
| last 24 hours? | these users? |
| | 3. Which file has been exfiltrated |
| | maximum times in last 24 hours? |
| | 4. List all the data exfiltration activities |
| | involving user x in the last 7 days? |

### Architecture Overview

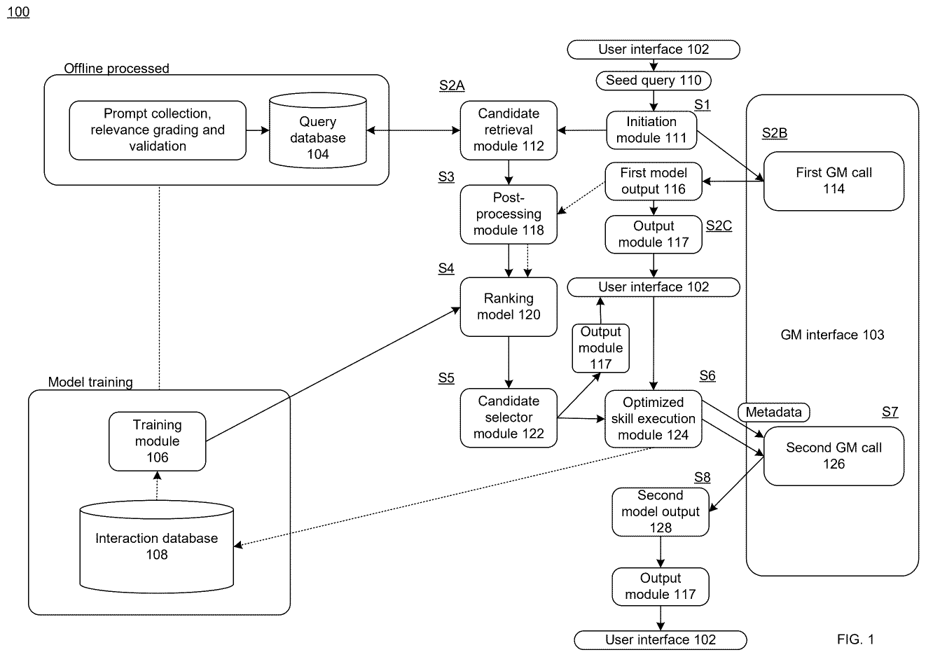

FIG. 1 shows a block diagram of a system 100. In brief, the system 100 causes a seed query 110 to be executed. In this example, the system 100 causes the seed query 110 to be executed by instigating a first GM call 114 based on the seed query 110, resulting in a first model output 116, which is a first model-generated response to the seed query 110. In addition, the system 100 determines one or more candidate next queries, and causes a next query selected from the one or more candidate next queries to be executed. In the following examples, the selected next query is caused to be executed by the system 200 instigates a second GM call 126 on the selected next query, resulting in a second model output 128, which is a second model-generated response to the selected candidate next query. In some implementations, an action (such as a security mitigation action or other type of action, such as one of those mentioned above) is performed on or using a device (or devices) based on the second model-generated response (e.g., based on both the first model-generated response and the second model-generated response). More generally, the system controls operation of a device or devices to implement such actions and/or other actions based on execution of the selected next query (e.g. based on execution of the selected next query and execution of the seed query 110).

There are many ways a multi-query GM interaction can be used to instigate automated actions or semi-automated actions. A semi-automated action is an action that is determined automatically but only triggered in response to user input. For example, in one use case, the seed query 110 instigates a GM analysis, such as an anomaly detection analysis performed on a dataset. In this case, candidate next queries might be proposed for refining or regressing the analysis, or for identifying or performing actions to be performed based on the analysis results (e.g., “propose a suitable mitigation action to address any identified anomalous entities” or “automatically revoke admin privileges for any identified anomalous or suspicious user identities”). In another example use case, the seed query 110 pertains to a security policy or a set of security policies (e.g. “identify all my data loss prevention policies”, in which case the candidate next queries might relate to appropriate follow ups (e.g., “Extend this policy to admin users”, “Make sure this condition is applied to all users”, “Add file download activity as a condition for all users in the marketing group”, “Identify any policy gaps and modify the policy to close these gaps” or “check this policy is complete, and if it is not complete, list any policy gaps and steps for closing them, and if it is complete, deploy and activate the policy”.) Another use case is image generation. In this case, the seed query may for example contain instructions for generating an image, and the candidate next queries might contain possible ways to refine the image generation process. In another use case, the seed query relates to machine optimization, for example instructing a GM to analyse a dataset relating to industrial machinery in order to detect possible faults or issues, or to perform machine optimizations. In this case, the candidate next queries may for example contain suggestions for extending the analysis or acting on it (e.g., “identify all machines in the same manufacturing batch” or “propose a suitable action for mitigating the issue or extending the working life of the machine”). Another example use case is medical diagnostics. For example, the seed query 110 might instruct a GM to perform a diagnostic analysis of a patient dataset (single patient or multi-patient), and the candidate next queries might contain suggestions to advance or test the diagnosis, or to generate a treatment plan (e.g., “cross-check your diagnosis with the patient's age and gender” or “propose a suitable treatment plan”). Another example generation is code synthesis, in which a guided multi-prompt interaction is used to automatically generate executable code to perform some task or function. In this context, an example of an automated or semi-automated action is executing code contained in the model response (e.g. in the response to a selected next query).

In any of the aforementioned examples, a model-generated response (e.g., response to a selected next query) can comprise text, image data, audio data, or computer code executable on a processor etc., or two or more such modalities.

Alternatively or additionally, examples of actions performed based on a model response (e.g., a response to a selected next query) include controlling or implementing a technical process. Other examples are detecting, identifying or mitigating a fault, anomaly or instance of suspicious activity in a machine, device, system or network.

To support the aforementioned functions, the system 100 is shown to comprise a query database 104, an initiation module 111, a candidate retrieval module 112, an output module 117, a post-processing module 118, a ranking model 120, a candidate selector module 122 and an optimized skill execution module 124. Steps of pipeline flow and description of each corresponding module is set out below.

At step S1, the process is initiated based on the seed query 110. The initiation module 111 receives the seed query 110 as input. Note, the term “query” is used herein in a broad sense to refer to any form of input to an interface, model, system etc., or an example of such an input (e.g. a predefined input), or a template for constructing such an input, etc. In particular, the term “query” does not necessarily imply a question. In some examples, a query is or comprises a direct instruction or command (natural language or structured) to perform a specific action.

In the present example, the seed query 110 is an open user prompt received via a user interface (UI) 102, such as a GUI. In this example, an initiation interaction involves receiving the user prompt as user input to the user interface 102. The following description refers to a user prompt, but the description applies equally to other forms of seed query (open or structured).

In other embodiments, the system 100 comprises an autonomous agent that generates the seed query 110. For example, in some implementations, an autonomous agent autonomously generates the seed query 110, autonomously selects a candidate next query (e.g. highest-ranked candidate next query), and autonomously performs or triggers an action (such as a security mitigation action) based on the first model output 116 and the second model output 128.

The initiation module 111 initiates two parallel calls based on the seed query, denoted as steps S2A and S2B respectively.

At step S2A, the candidate retrieval module 112 performs a vector search in the query database 104, which is implemented as a vector database (VDB) in this example. The VDB stores pre-processed queries (e.g., prompts) and their embedding vectors. Top results are selected, which exceed a predefined threshold of embedding vector similarity. The candidate retrieval model 112 outputs a shortlist of candidate queries in this manner. Among all results, search results are limited to less than a pre-determined number of candidate next queries in total, where that number is denoted N below. A process of storing information in the query database 104 involves query collection, relevance grading and validation in one implementation. This process is detailed below in the section “Offline Process”.

At step S2B, the initiation module 111 initiates a first GM call 114 on the seed query 110 via a GM interface 103. In response to the first GM call 114, at step S2C, the GM interface 103 returns a first model output 116. The output module 117 receives the first model output 116, and causes the first model output 116 to be rendered in the user interface.

As described above, a GM call involves inputting a query to a generative model, and in some cases involves additional skill orchestration. As described in further detail below, for candidate queries stored in the query database 104, associated metadata is used to bypass skill orchestration and invoke the appropriate GM skill call directly. However, for the seed query 110, no extra meta data is passed during the first GM call 114 and the system 100 uses skill orchestration to determine and invoke an appropriate GM skill. Therefore, the first GM call 114 involves full skill orchestration, instigated via the GM interface 103, to select and initiate an appropriate GM skill for responding to the seed query 110.

When a GM skill is invoked on a given query, the GM skill generates a response that is rendered in the GUI in this example. Responses to seed queries and selected next queries are rendered in the same way in this example. As noted, in other examples, GM outputs are alternatively or additionally used by an autonomous agent to autonomously perform actions, such as security mitigation actions.

At step S3, the post-processing module 118 receives the shortlist of candidate queries output from the candidate retrieval module 112 and outputs a modified set of one or more candidate queries. To generate the modified set, the output of the search results of step S2A is subject to candidate post-processing because standard search algorithms tend to be greedy, relying solely on similarity metrics. While this approach can effectively identify paraphrased versions of the same question, it is not optimal per se for determining subsequent actions or recommendations. Therefore, post-processing is used to optimize the shortlist of candidate queries for next query selection. In some examples, the shortlist of candidate queries produced by the candidate retrieval module 112 in step S2A is ranked according to embedding similarity, which will not necessarily reflect “next query” suitability. In one example, the post-processing module 118 uses a term frequency-inverse document frequency (TF-IDF) approach to apply weighting/distance criteria to reorder or eliminate irrelevant or overly greedy candidates. The post-processing module 118 passes the modified candidate query set to the ranking model 120 for “re-ranking” according to suitability as a follow up to the seed query 110. The term re-ranking is used, as the ranking of candidate queries according to relative suitability may well be different than their ranking according to embedding vector similarity. Note, in the most general sense, “ranking” refers to a process of assigning relevance scores denoting next query relevance. In some (but not all) implementations, ranking additionally involves ordering candidates based on those scores. In other implementations, ranking additionally involves filtering candidates based on those scores. Some implementations involve both ordering and scoring.

As noted, in some embodiments, the first model output 116 (generated in response to the seed query 110) is also used in the candidate query re-ranking process. In some such embodiments, the first model output 116 is also consumed by the post-processing module 118. In this context, post-processing of model-generated responses is an useful extension, as responses can often be lengthy, generic, and cover multiple intents. For example, delivering an entire paragraph (or more than one) at once may result in focusing on a single, narrow intent. In some such embodiments, during post-processing, the post-processing module 118 breaks down the first model output 116 into multiple segments, each conveying different intents, resulting in a post-processed first model output denoted by a dotted arrow from the post-processing module 118 to the ranking model 120. This ensures that subsequent suggestions address various dimensions of the recommendation.

An illustrative example of a first model output, and the corresponding post-processed model output, are given in Table 2.

TABLE 2

| Model output | Post-Processed model output |
|---|---|
| “Based on our analytics of risks in | [“high volume of finance files |
| your organization over the last 30 days, | that are uploaded to whatsapp |
| here is a recommendation on what you | which is a suspicious domain”, |
| could prioritize: | |
| 1. There is high volume of finance files | “recommend an Endpoint DLP |
| that are uploaded to whatsapp which is | Policy for protection against |
| a suspicious domain. We recommend an | such exfiltration”, |
| Endpoint DLP Policy for protection | |
| against such exfiltration | |
| 2. We have also found users frequently | “users frequently sharing |
| sharing credentials over teams and this | credentials over teams”, |
| presents high risk to your org. We | “create a policy for credentials |
| recommend creating a policy for | on Teams”] |
| credentials on Teams. | |
| We recommend the above two for | |
| immediate action.” | |

Although the post-processing module 118 is shown as a single component, separate query post-processing and response post-processing sub-modules are implemented in some embodiments.

At step S4, the ranking model 120 receives the seed query 110 and the modified candidate query set. The modified candidate query set comprises post-processed search results in this example, which are the refined search results obtained from the post-processing module 118, which have been processed to filter to remove any non-relevant results.

In some embodiments, the ranking model 120 additionally receives the post-processed first model output to the seed query 110 (the response generated by the GM skill based on the seed query 110 in this example, which provides a preliminary answer or preliminary information).

The ranking model 120 evaluates the relevance of the received candidates inputs and computes a relevance score associated with each candidate query. The ranking model 120 uses the seed query 110 to do so and, in some implementations, the post-processed first model output. As indicated, the ranking model 120 is an ML model (e.g., DL and/or RL model) which has been specifically trained on next query ranking. FIG. 1 shows a training module 106 that performs training and periodic re-training of the ranking model 120. Re-training uses interaction logs collected and stored in an interaction database 108. Further details of a suitable ranking model training process are described below in the “Model Training” section.

The ranking model 120 passes an array of relevance scores to a candidate selector module 122.

At step S5, the candidate selector module 122 receives the relevance scores for each candidate next query from the ranking model 120, and computes their rankings, outputting a list of candidate queries ordered based on their relevance scores (re-rank list). In some embodiments, the candidate selector module 122 simply orders and/or filters candidate queries by their relevance scores as computed by the ranking model 120. In other embodiments, the candidate selector module 122 uses one or more additional criteria together with the relevance scores in determining final candidate query rankings (e.g. final query relevance scores), which may be different from those assigned by the ranking model 120. In some such embodiments, the candidate selector module 122 integrates diverse configurations to deliver targeted or exploratory suggestions across various scenarios and products. In some such embodiments, the candidate selector module 122 balances exploiting current user intent with exploring related but distinct intents, resulting in a ranked list of queries to maximize the efficiency of subsequent user-GM interaction.

When candidate queries are filtered based on their scores (e.g. to output only a subset of one or more candidate queries with the highest relevance scores), the result is a filtered set of one or more candidate next queries.

At step S6, the candidate selector module 122 outputs a list of query suggestions to the output module 117 for rendering in the user interface 102, thereby enabling ranked query selection within the user interface 102. For example, in some implementations, the candidate next queries are ordered in the user interface based on their final rankings. In some implementations, the candidate next queries are filtered based on their final rankings, e.g. only outputting a predetermined number of top-ranked queries or only outputting candidate next queries having final relevance scores above a predetermined threshold.

Each candidate query is associated with metadata, which includes specific details related to its associated candidate query. In this example, the metadata is not displayed in or otherwise outputted via the user interface 102. However, in response to a user input that selects one of the candidates queries, the candidate selector module 112 passes the associated metadata along with the selected query as input to the optimized skill execution module 124.

At step S7, the optimized skill execution module 124 instigates the second GM call 126 based on the selected next query and its associated metadata, ensuring that the second model output 128 is tailored to the selected next query. This metadata helps in refining the context and improving the second model output 128, but with a significantly reduced computational burden compared with full skill orchestration.

In the presently described example, the optimized skill execution module 124 thus initiates the second GM 126 call based on user selection of a suggested query. The optimized skill execution module 124 transmits to the GM interface 103 the associated metadata with the selected query during the second GM call. By embedding this metadata, the optimized skill execution module 124 significantly reduces execution latency, as the optimized skill execution module 124 bypasses skill orchestration (which would otherwise involve multiple intermediate steps to identify an appropriate GM skill). This optimization enhances computational efficiency and ensures a more responsive system, thereby improving the overall user experience. The “Offline Process”, section below provides further details (see e.g., Table 3, for specific examples).

Whilst in the present example, a next query is selected manually from the outputted candidates, in other implementations the second GM call 126 is instigated automatically, e.g. based on the candidate next query having a highest final ranking. In some such implementations, multiple second queries are instigated automatically, e.g. in some implementations, respective second GM calls are instigated automatically on a predetermined number of top-ranked queries or candidate next queries having final relevance scores above a predetermined threshold.

At step S8, the output module 117 receives the second model output 128 and outputs the second model output 128 to the user interface 102.

In other implementation, alternatively or additionally, the system 100 automatically triggers an action based on the second model output 128 (e.g., based on the first model output 116 and the second model output 128).

Some embodiments involve converting a seed query into a vector, performing a vector similarity search of a VDB that stores predefined queries that are each associated with corresponding code or metadata to perform a different domain-specific task. In the above examples, candidate queries are stored metadata to bypass GM skill orchestration. In other embodiments, other functionality can be implemented using metadata and/or computer-readable code stored in association with candidate queries. For example, in some implementations, pre-generated executable code is stored in association with a candidate query in some cases, which is executed upon selection of that query to cause some predetermined action to be performed. For example, this could involve some procedural/rules-based data processing operation that is applied to related data (such as filtering, data selection, data aggregation etc.), which is turn is passed as an input to a GM model. In some implementations, the system executed model-generated code automatically or in response to user input.

As indicated, the first GM call 114 and/or the second GM call 126 are supported by an external knowledge base in some examples. For example, in a security application, entity data is contained in a knowledge base enabling a generative model to perform functions such as anomaly detection, threat detection etc. on the entity data. Various techniques can be used to pass such data to a GML, including for example retrieval-augmented generation (RAG), in-context learning etc. In other applications, different knowledge bases are used to supplement information contained in a user query and/or a selected next query.

### Offline Process

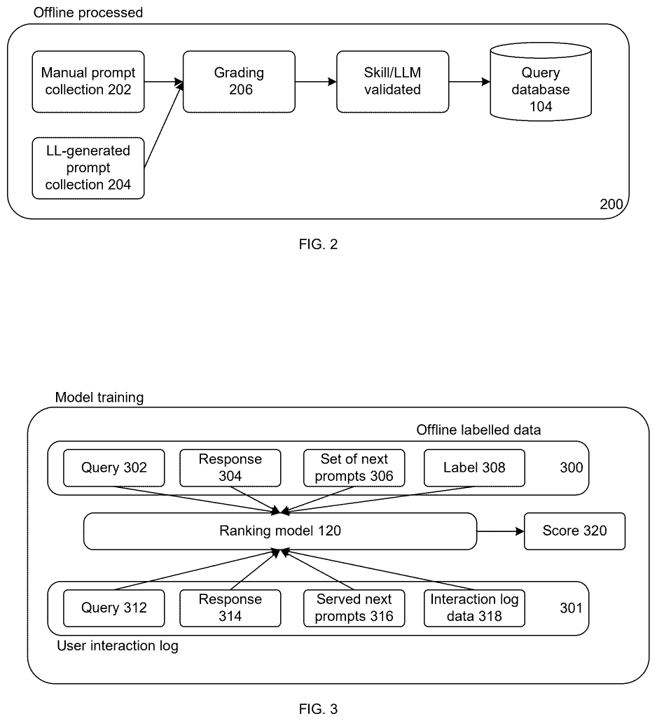

FIG. 2 shows an offline processing system 200, which implements an offline data collection and grading process used in some implementations to populate the query database 104.

In this example, the query database 104 is populated based on a combination of manual queries and model-generated queries, e.g. queries generated using a generative LM (e.g., LLM).

A manual query collection module 202 collects queries from subject matter experts (SMEs) in a relevant domain or domains.

An LM query collection module 204 collects model-generated queries, which have been generated by a Language Model (e.g. LLM) under diverse instructions.

A grading module 206 generates labeled data by ranking triplets of queries based on their relevance. An interface receives as input a three-dimensional vector of queries, where the first entry is a pivot-query and the other two are potential follow-ups. SMEs grade these based on their relevance to the pivot. As well as being used to populate the query database 104, this labeled data is used to train the model (see FIG. 3 and accompanying description). An alternative implementation of the grading module 206 uses a query and its corresponding response as the first entry, with the other two entries being possible suggested queries. SMEs grade these in the context of the pivot query and its response.

In a skill validation step, high-quality queries are selected from the graded queries, and processed them through a skill/GM to generate metadata (structured metadata of the form used to perform the second GML call 126 in FIG. 1). The selected queries and their high-quality metadata are stored in the query database 104 (e.g., for use in step S2A of FIG. 1).

Table 3 shows examples of candidate queries and example associated metadata stored in the query database 104.

TABLE 3

| Next Query | Structured metadata |
|---|---|
| How can I create insider | {SkillName: “KnowledgeHub”, |
| risk policy | Parameter: {[ ]}} |
| Find users sending email | {SkillName: “DataSecurityAnalytics”, |
| containing offensive | Parameter: |
| language | {APIMapper: ”DataSecurityUsersInsight”}} |

As discussed, with the relevant metadata (and in some implementations the first model output 116), the system 100 can invoke the next skill directly, bypassing an expensive skill orchestration step. This greatly saves the subsequent processing on both latency and cost.

Table 4 shows an example of a schema used in some implementations to store candidate queries (natural language prompts in this example) and their associated metadata in the query database 104.

TABLE 4

| Parameter | Description |
|---|---|
| Prompt | Text recommending as follow |
| | up question |
| Embedding | A vector representing Prompt |
| Language | Language of Prompt |
| Scenario | DSA, PolicyUnderstanding, KB etc |
| Product | Applicability to a specific |
| | software product or products |
| | (e.g. security products) |
| SkillName | Skill Name which will answer |
| | corresponding Prompt |
| {{Skillparam1: ”text1”, | A dictionary of next prompts |
| Skillparam2: ”text2” . . . }} | and corresponding skill name |
| | and skill parameters as metadata |

### Model Training

As discussed, the ranking model 120 (such as a DL and/or RL model) is trained to generate next query suggestions. The ranking model 120 is trained based on labeled sample collected over the relevant domain or domains (e.g., compliance, governance and security domains in one example).

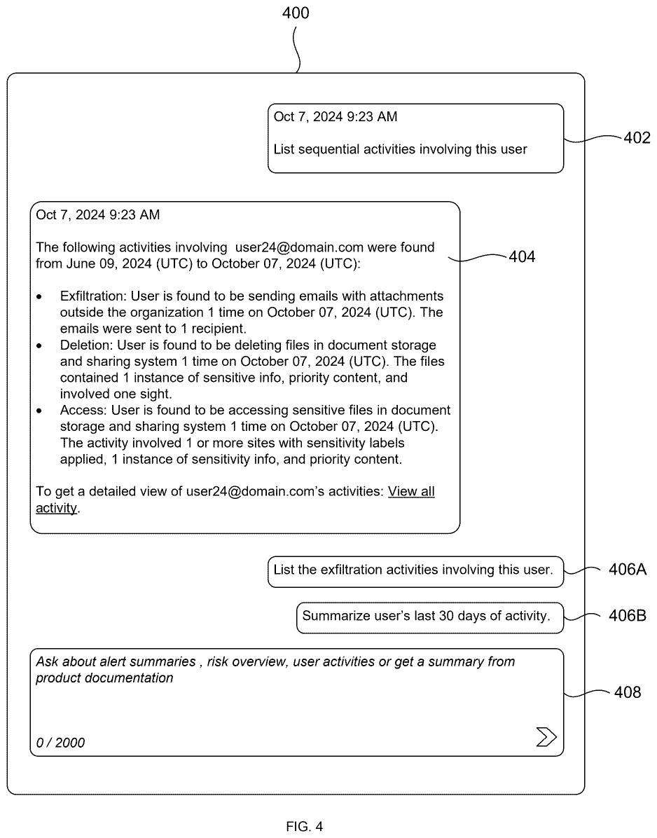

FIG. 4 shows a schematic overview of a training setup used by for training the ranking model 120 by the training module 106 of FIG. 1.

The ranking model 120 is engineered to flexibly score the relevance of next query suggestions based on a specific domain context. The ranking model 120 has flexibility to score a query in terms of “next query relevance” based on a specific domain.

Initially, the ranking model 120 is developed and trained offline using a non-customized dataset (e.g., a different dataset collected for a different domain). The ranking model 120 has an architecture that allows it to adapt its scoring mechanism to each domain, ensuring high relevance and accuracy in its suggestions.

Although the ranking model 120 is initially trained offline, once deployed, in some implementations, the ranking model 120 is refined (e.g. fine-tuned or otherwise re-trained) based on collected user feedback-both positive and negative. With a feedback loop connected to the ranking model 120, the performance of the ranking model 120 continue to improve with every batch of user feedback passed to a model training pipeline. One of the key benefits of this model is its ability to learn and improve continuously through user feedback. Both positive and negative feedback from users is integral to this process. By incorporating a feedback loop, the model can refine weights of different layers and enhance its performance with each batch of user feedback that is fed into the model training pipeline. User feedback is implicit, and is gathered by recording which recommended candidate queries are selected when the system is in use, and which are not. Such data is collected in the interaction database 108 for use by the training module 106 of FIG. 1.

### Offline Labelled Data

FIG. 3 shows an example of an offline training example 300, shown to comprise a query 302, a response 304, a set of candidate next queries 306 and a label 308 assigned by a SME in the manner described above with reference to FIG. 2. The ranking model 120 is trained to generate score 320 denoting next query relevance.

In the pipeline above, the model undergoes initial training using offline labelled data. This labelled data is curated and encompasses four useful dimensions of information in this example.

The query 302 is an example of initial seed input that initiates an interaction.

The response 304 is an example of a response generated by an applicable GM or GM skill based on to the query 302.

The set of next queries 306 is a collection of potential follow-up queries that could logically succeed the initial interaction.

The label 308 assigns a relevancy order to the set of next queries 306. This is a rank order that labels the candidate next queries based on their relevance and appropriateness in relation to the initial query 302 and response 304.

This structured approach ensures that the ranking model 120 is trained on a diverse and comprehensive dataset, enabling it to understand and predict the most relevant next queries with high accuracy. By incorporating these four dimensions, the model can effectively learn the contextual relationships and dependencies between queries and responses, which is useful for generating meaningful and contextually appropriate suggestions.

As noted, in some implementation, the model-generated response to the seed query is not used by the ranking module 120. In such implementations, the response 304 is omitted from the offline training data.

### User Interaction Log

A user interaction training example 301 is shown to comprise a query 312, a response 314, a set of served candidate next queries 316, and interaction log data 318 (in place of the SME-assigned label 308).

Once the ranking model 120 is online, recorded user interactions enable the system 100 to determine which queries are selected or not selected by users. This interaction log is fed into the ranking model 120, enabling it to autonomously learn from feedback loop and improve its relevance scoring. Whereas for offline data, relevance is assigned by an SME, with recorded interaction data, relevance is determined by recorded user interactions. In this context, the interaction log data 318 assigns a ranking to the served candidate next queries 316. Served candidate next queries mean candidate next queries determined and outputted using the pipeline flow of FIG. 2.

The feedback loop operates as follows: once the ranking model 120 is deployed, it takes data on user interactions. This includes which queries are selected, which are ignored, and any other relevant user behaviors. This interaction data is then analyzed and used to update the ranking model's parameters, thereby re-training the ranking model 120 on real-world usage patterns.

As a result, the ranking model 120 is updated over time, becoming more accurate in identifying and suggesting the most relevant next queries. This continuous improvement cycle ensures that the model remains effective and responsive to changing user needs and preferences.

By leveraging DL and RL techniques, along with a robust feedback mechanism, the ranking model is poised to deliver highly accurate and contextually appropriate query suggestions, significantly enhancing user experience and engagement.

### User Experience

FIG. 4 show an example of a seed query 402 rendered in a GUI 400, with a first model response 404 to the seed query 402 obtained in a first GM call (corresponding to step S2B in FIG. 1), and first and second candidate next queries 406A, 406B determined and presented as per steps S2A and steps S3 to S5 of FIG. 1. Each candidate next query 406A, 406B is selectable to automatically invoke a second GM call on the selected query and its associated metadata. The seed query 402 has the form of an open natural language prompt in this example, which has been entered in an input field 408.

In this example, a single entity has been identified in the model-generated response, which is a user identifier (in the form of an email address) in this example. This entity has been identified by a GM based on a dataset of recorded entity activity (e.g. a set of entity activity records). A selectable link is generated, which is selectable to access further details of the activity, e.g. one or more elements (e.g. records) within the dataset associated with the identified entity (enabling an analyst to access the relevant raw data). In some embodiments, the model-generated response is parsed using a separate entity extraction module (e.g. non-GML entity extraction module, such as a rules-based/procedural module) to identify and extract an identifier or identifiers of any entity or entities mentioned in the model-generated response. For each extracted entity identifier, the entity extraction module generates a link for retrieving the element(s) of the dataset associated with that entity.

Although not depicted in this example, alternative or additional non-GML option(s) are presented in some embodiments. For example, in some security implementations, a selectable option is presented, which is selectable to trigger a predetermined security mitigation action on an entity identified in the model-generated response (such as isolating or quarantining the entity, revoking or limiting an entity's credentials, access privileges etc.). In other embodiments, such an action may be performed automatically based on the model-generated response, without requiring user input to trigger the action.

Below is an example of a user prompt (a “context” input in this example) and three selected candidate prompts, together with their embedding vectors. In this example, all prompts have identical embedding vectors. In practice, they may have different embedding vectors, with the candidates selected based on similarity (e.g. Euclidian distance or cosine distance) in embedding space, e.g. based on a distance threshold relative to the seed query embedding vector.

```
{
  ...
  “context”: {
    “userPrompt”: “What are the alerts which need immediate
attention?”,
    “userPromptEmbedding”: [0.98, 0.45, 0.67, 0.23]
  },
  “rankContent”: [
    {
      “id”: “prompt1”,
      “nextPrompt”: “How many users are identified in the above
alerts?”,
      “nextPromptEmbedding”: [0.98, 0.45, 0. 67, 0.23]
    },
    {
      “id”: “prompt2”,
      “nextPrompt”: “What are the user risk profiles associated with
this alert?”,
      “nextPromptEmbedding”: [0.98, 0.45, 0.67, 0.23]
    },
    {
      “id”: “prompt3”,
      “nextPrompt”: “Which file has been exfiltrated and what's the
location?”,
      “nextPromptEmbedding”: [0.98, 0.45, 0.67, 0.23]
    }
  ]
}
```

Below is an example of an output of the ranker model 120 in one implementation:

```
{
  “id”: “56784921-61aa-44b9-9ae5-548615492657”,
  “results”: [
  {
      “contentRankScores”: [
        {
          “id”: “prompt1”,
          “score”: 0.95
        },
        {
          “id”: “prompt2”,
          “score”: 0.85
        },
        {
          “id”: “prompt3”,
          “score”: 0.70
        }
      ],
      “exceptions”: [
        {
          “type”: “ValidationError”,
          “message”: “Invalid content ID”
        }
      ],
      “modelIdentifier”: {
        “scenario”: “Compliance”,
        “category”: “8aef6743-61aa-44b9-9ae5-3bb3d77df535”,
        “algorithmType”: “onnx”,
        “version”: “1”,
        “isoob”: true
      }
    }
  ]
}
```

### Example Implementing Environment

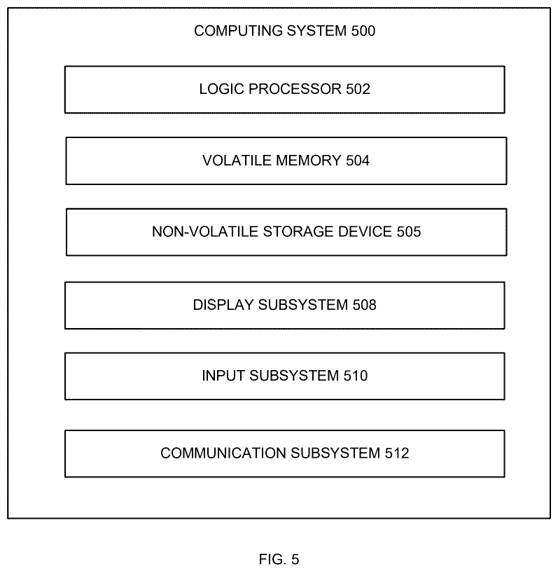

FIG. 5 schematically shows a non-limiting example of a computing system 500, such as a computing device or system of connected computing devices, that can enact one or more of the methods or processes described above. Computing system 500 is shown in simplified form. Computing system 500 includes a logic processor 502, volatile memory 504, and a non-volatile storage device 505. Computing system 500 may optionally include a display subsystem 508, input subsystem 510, communication subsystem 512, and/or other components not shown. Logic processor 502 comprises one or more physical (hardware) processors configured to carry out processing operations. For example, the logic processor 502 may be configured to execute instructions that are part of one or more applications, programs, routines, libraries, objects, components, data structures, or other logical constructs. The logic processor 502 may include one or more hardware processors configured to execute software instructions based on an instruction set architecture, such as a central processing unit (CPU), graphical processing unit (GPU), tensor processing unit (TPU) or other form of accelerator processor. Additionally or alternatively, the logic processor 502 may include a hardware processor (or processors)) in the form of a logic circuit or firmware device configured to execute hardware-implemented logic (programmable or non-programmable) or firmware instructions. The processor(s) of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 502 may be virtualized and executed by remotely accessible, networked computing devices configured in a cloud-computing configuration. In such a case, these virtualized aspects are run on different physical logic processors of various different machines. Non-volatile storage device 505 includes one or more physical devices configured to hold instructions executable by the logic processor 502 to implement the methods and processes described herein. When such methods and processes are implemented, the state of non-volatile storage device 505 may be transformed—e.g., to hold different data. Non-volatile storage device 505 may include physical devices that are removable and/or built-in. Non-volatile storage device 505 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive), or other mass storage device technology. Non-volatile storage device 505 may include nonvolatile, dynamic, static, read/write, read-only, sequential-access, location-addressable, file-addressable, and/or content-addressable devices. Volatile memory 504 may include one or more physical devices that include random access memory. Volatile memory 504 is typically utilized by logic processor 502 to temporarily store information during processing of software instructions. Aspects of logic processor 502, volatile memory 504, and non-volatile storage device 505 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 505, using portions of volatile memory 504. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 508 may be used to present a visual representation of data held by non-volatile storage device 505. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 505 in a shared enclosure, or such display devices may be peripheral display devices. When included, input subsystem 510 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 514 may be configured to communicatively couple various computing devices described herein with each other, and with other devices. Communication subsystem 514 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the internet. The term computer readable media as used herein includes computer storage media. Computer storage media includes, among others, volatile and non-volatile, removable and nonremovable media (e.g., volatile memory 504 or non-volatile storage 505) implemented in any method or technology for storage of information, such as computer readable instructions, data structures, or program modules. Computer storage media includes, among others, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g., the computing system 500 or a component device thereof). Computer storage media does not include a carrier wave or other propagated or modulated data signal. Communication media are in some examples embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. By way of example, and not limitation, communication media includes wired media such as a wired network or direct wired connection, and wireless media such as acoustic, radio frequency (RF), infrared, and other wireless media.

Example aspects and embodiments are set out below.

Example 1. A computer-implemented method comprising: receiving a seed query; retrieving from a database: a first candidate query based on matching the seed query with the first candidate query, and a second candidate query based on matching the seed query with the second candidate query; assigning based on the seed query, using a ranking model: a first relevance score to the first candidate query, and a second relevance score to the candidate second query; and outputting the candidate first query based on the first relevance score and the second relevance score.

Example 2. The method of Example 1, comprising: instigating based on the seed query a first generative model (GM) call; receiving a first model-generated response based on the first GM call; instigating based on the first candidate query a second GM call; and receiving a second model-generated response based on the second GM call.

Example 3. The method of Example 2, comprising: causing the first model-generated response to be displayed in a graphical user interface (GUI); wherein outputting the first candidate query comprises causing the first candidate query to be displayed in the GUI, wherein the first candidate query is inputted to the GM in response to a user input denoting selection of the first candidate query within the GUI, and wherein the method comprises causing the second model-generated response to be displayed in the GUI.

Example 4. The method of Example 3, wherein outputting the first candidate query comprises causing to displayed in the GUI the first candidate query and the second candidate query ordered based on the first relevancy score and the second relevance score.

Example 5. The method of any of Examples 1 to 4, wherein outputting the first candidate query comprises outputting: a candidate query list in which the first candidate query and the second candidate query are ordered based on the first relevance score and the second relevance score, or the first candidate query in association with the first relevance score and the second candidate query in association with the second relevance score.

Example 6. The method of any of Examples 1 to 5, comprising: detecting based on content of the seed query a first generative model (GM) skill; instigating, based on the seed query and the first GM skill, a first GM call; receiving a first model-generated response based on the first GM call; determining, based on first metadata associated with the first candidate query in the database, a second GM skill; instigating, based on the first candidate query and the second GM skill, a second GM call; and receiving a second model-generated response based on the second GM call.

Example 7. The method of any of Examples 1 to 6, wherein the seed query relates to a dataset, the method comprising extracting a detection from the dataset using a generative model and the first candidate query.

Example 8. The method of any of Examples 1 to 7, wherein the dataset relates to entity activity within a computer system or a computer network, and the detection is an incident of potentially suspicious entity activity.

Example 9. The method of Example 8, comprising performing based on the detection a security mitigation action.

Example 10. The method of Example 9, wherein the security mitigation action comprises: generating an alert, revoking or restricting an access privilege of an entity associated with the detection, quarantining an entity associated with the detection, or isolating from the computer system or the computer network an entity associated with the detection.

Example 10. The method of any preceding Example, wherein outputting the first candidate query comprises outputting the first candidate query and the second candidate query ordered based on the first relevance score and the second relevance score.

Example 11. The method of any preceding Example, comprising filtering the first candidate query and the second candidate query based on the first relevance score and the second relevance score, wherein outputting the first candidate query comprises outputting a filtered candidate set comprising the first candidate query.

Example 12. A computer-implemented method comprising: receiving a seed query; instigating based on the seed query a first generative model (GM) call; receiving a first model-generated response based on the first GM call; retrieving from a database a candidate query based on matching the seed query with the first candidate query; assigning based on the seed query, using a ranking model, a relevance score to the candidate query; based on the candidate query and the relevance score, instigating a second GM call; and receiving a second model-generated response based on the second GM call.

Example 13. The method of Example 12, wherein the first candidate query and the second candidate query are retrieved based on the first model-generated response.

Example 14. The method of Example 2 or 12, any Example dependent thereon, wherein the second model-generated response comprises model-generated: text, image data, audio data, or computer code executable on a processor.

Example 15. The method of Example 2 or 12, or any Example dependent thereon, comprising, based on the second model-generated response: controlling or implementing a technical process; detecting, identifying or mitigating a fault, anomaly or instance of suspicious activity in a machine, device, system or network; performing a medical diagnosis; or causing code contained in the second model-generated response to be executed on a processor.

Example 16. A computer-implemented method comprising: receiving a seed query; retrieving from a database a candidate query based on matching the seed query with the candidate query; assigning based on the seed query, using a ranking model, a relevance score to the candidate query; based on the candidate query and the relevance score, instigating a generative model (GM) call; receiving a model-generated response based on the GM call; and triggering an action based on the model-generated response.

Example 17. The method of Example 16, wherein the action comprises an action recited in Example 15.

Example 18. A computer-implemented method, comprising: receiving a seed query; retrieving from a database: a first candidate query based on matching the seed query with the first candidate query, and a second candidate query based on matching the seed query with the second candidate query; assigning based on the seed query, using a ranking model: a first relevance score to the first candidate query, and a second relevance score to the second candidate query; and based on the first relevance score and the second relevance score, causing the first candidate query to be executed; and controlling a device based on executing the first candidate query.

Example 19. The method of Example 18, comprising: instigating based on the seed query a first generative model (GM) call; and receiving a first model-generated response based on the first GM call; wherein causing the first candidate query to be executed comprises instigating based on the first candidate query a second GM call; and wherein the method further comprises receiving a second model-generated response based on the second GM call, the device being controlled based on the second model-generated response.

Example 20. The method of Example 19, wherein the second model-generated response comprises model-generated: text, image data, audio data, or computer code executable on a processor.

Example 21. The method of any of Examples 18 to 20, comprising, based on the executing the first candidate query controlling or implementing a technical process using the device; detecting, identifying or mitigating, using the device, a fault, anomaly or instance of suspicious activity in a machine, device, system or network; performing, using the device, a medical diagnosis; or causing code contained in the second model-generated response to be executed on a processor of the device.

Example 22. The method of Example 19, comprising: causing the first model-generated response to be displayed in a graphical user interface (GUI); wherein controlling the device comprises causing the device to output the first candidate query comprises causing the first candidate query to be displayed in the GUI, wherein the first candidate query is inputted to the GM in response to a user input denoting selection of the first candidate query within the GUI, and wherein the method comprises causing the second model-generated response to be displayed in the GUI.

Example 23. The method of Example 22, wherein controlling the device comprises causing the device to display in the GUI the first candidate query and the second candidate query ordered based on the first relevancy score and the second relevance score.

Example 24. The method of any of Examples 18 to 23, comprising: detecting based on content of the seed query a first generative model (GM) skill; instigating, based on the seed query and the first GM skill, a first GM call; receiving a first model-generated response based on the first GM call; and determining, based on first metadata associated with the first candidate query in the database, a second GM skill; wherein causing the first candidate query to be executed comprises instigating, based on the first candidate query and the second GM skill, a second GM call; wherein the method comprises receiving a second model-generated response based on the second GM call, the device being controlled based on the second model-generated response.

Example 25. The method of any of Examples 18 to 24, wherein the seed query relates to a dataset, the method comprising extracting a detection from the dataset using a generative model and the first candidate query.

Example 26. The method of Example 25, wherein the dataset relates to entity activity within a computer system or a computer network, and the detection is an incident of potentially suspicious entity activity.

Example 27. The method of Example 26, wherein controlling the device comprises performing based on the detection, using the device, a security mitigation action.

Example 28. A computer system comprising: at least one processor; and at least one memory coupled to the at least one processor, and comprising computer-readable instructions configured so as, when executed on the at least one processor, to cause the at least one processor to implement the method of any of Examples 1 to 27.

Example 29. A computer-readable storage medium comprising computer-readable instructions configured so as, when executed on at least one processor, to cause the at least one processor to implement any of Examples 1 to 27.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure.

1. A computer-implemented method, comprising:
receiving a seed query;
retrieving from a database:
a first candidate query based on matching the seed query with the first candidate query, and
a second candidate query based on matching the seed query with the second candidate query;
assigning based on the seed query, using a ranking model:
a first relevance score to the first candidate query, and
a second relevance score to the second candidate query; and
based on the first relevance score and the second relevance score, causing the first candidate query to be executed; and
controlling a device based on executing the first candidate query.

2. The method of claim 1, comprising:
instigating based on the seed query a first generative model (GM) call; and
receiving a first model-generated response based on the first GM call;
wherein causing the first candidate query to be executed comprises instigating based on the first candidate query a second GM call; and
wherein the method further comprises receiving a second model-generated response based on the second GM call, the device being controlled based on the second model-generated response.

3. The method of claim 2, wherein the second model-generated response comprises model-generated:
text,
image data,
audio data, or
computer code executable on a processor.

4. The method of claim 2, comprising:
causing the first model-generated response to be displayed in a graphical user interface (GUI);
wherein controlling the device comprises causing the device to output the first candidate query comprises causing the first candidate query to be displayed in the GUI, wherein the first candidate query is inputted to the GM in response to a user input denoting selection of the first candidate query within the GUI, and wherein the method comprises causing the second model-generated response to be displayed in the GUI.

5. The method of claim 4, wherein controlling the device comprises causing the device to display in the GUI the first candidate query and the second candidate query ordered based on the first relevancy score and the second relevance score.

6. The method of claim 1, comprising, based on the executing the first candidate query:
controlling or implementing a technical process using the device;
detecting, identifying or mitigating, using the device, a fault, anomaly or instance of suspicious activity in a machine, device, system or network;
performing, using the device, a medical diagnosis; or
causing code contained in the second model-generated response to be executed on a processor of the device.

7. The method of claim 1, comprising outputting:
a candidate query list in which the first candidate query and the second candidate query are ordered based on the first relevance score and the second relevance score, or
the first candidate query in association with the first relevance score and the second candidate query in association with the second relevance score.

8. The method of claim 1, comprising:
detecting based on content of the seed query a first generative model (GM) skill;
instigating, based on the seed query and the first GM skill, a first GM call;
receiving a first model-generated response based on the first GM call; and
determining, based on first metadata associated with the first candidate query in the database, a second GM skill;
wherein causing the first candidate query to be executed comprises instigating, based on the first candidate query and the second GM skill, a second GM call;
wherein the method comprises receiving a second model-generated response based on the second GM call, the device being controlled based on the second model-generated response.

9. The method of claim 1, wherein the seed query relates to a dataset, the method comprising extracting a detection from the dataset using a generative model and the first candidate query.

10. The method of claim 9, wherein the dataset relates to entity activity within a computer system or a computer network, and the detection is an incident of potentially suspicious entity activity.

11. The method of claim 10, wherein controlling the device comprises performing based on the detection, using the device, a security mitigation action.

12. The method of claim 11, wherein the security mitigation action comprises:
generating an alert,
revoking or restricting an access privilege of an entity associated with the detection,
quarantining an entity associated with the detection, or
isolating from the computer system or the computer network an entity associated with the detection.

13. The method of claim 1, comprising outputting the first candidate query and the second candidate query ordered based on the first relevance score and the second relevance score.

14. The method of claim 1, comprising:
filtering the first candidate query and the second candidate query based on the first relevance score and the second relevance score; and
outputting a filtered candidate set comprising the first candidate query.

15. A computer system comprising:
at least one processor; and
at least one memory coupled to the at least one processor, and comprising computer-readable instructions configured so as, when executed on the at least one processor, to cause the at least one processor to implement operations of:
receiving a seed query;
instigating based on the seed query a first generative model (GM) call;
receiving a first model-generated response based on the first GM call;
retrieving from a database a candidate query based on matching the seed query with the candidate query;
assigning based on the seed query, using a ranking model, a relevance score to the candidate query;
based on the candidate query and the relevance score, instigating a second GM call; and
receiving a second model-generated response based on the second GM call.

16. The computer system of claim 15, wherein the second model-generated response comprises model-generated:
text,
image data,
audio data, or
computer code executable on a processor.

17. The computer system of claim 15, comprising, based on the second model-generated response:
controlling or implementing a technical process;
detecting, identifying or mitigating a fault, anomaly or instance of suspicious activity in a machine, device, system or network;
performing a medical diagnosis; or
causing code contained in the second model-generated response to be executed on a processor.

18. The computer system of claim 15, wherein the candidate query is retrieved based on the first model-generated response.

19. A computer-readable storage medium comprising computer-readable instructions configured so as, when executed on at least one processor, to cause the at least one processor to implement operations of:
receiving a seed query;
retrieving from a database a candidate query based on matching the seed query with the candidate query;
assigning based on the seed query, using a ranking model, a relevance score to the candidate query;
based on the candidate query and the relevance score, instigating a generative model (GM) call;
receiving a model-generated response based on the GM call; and
triggering an action based on the model-generated response.

20. The computer-readable storage medium of claim 19, wherein the action comprises:
controlling or implementing a technical process;
detecting, identifying or mitigating a fault, anomaly or instance of suspicious activity in a machine, device, system or network;
performing a medical diagnosis; or
causing code contained in a second model-generated response instigated based on the candidate query to be executed on a processor.
